(19) United States
(12) Patent Application Publication
(10) Pub. No.: US 2025/0127593 A1
(43) Pub. Date: Apr. 24, 2025

(54) NON-SLIDING ARCHFORM DIRECTLY BONDED TO A PATIENT'S TEETH

(71) Applicant: Swift Health Systems Inc., Irvine, CA (US)

(72) Inventors: Todd Oda, Torrance, CA (US); Philong John Pham, Huntington Beach, CA (US); Monica Y. Suh, Irvine, CA (US)

(21) Appl. No.: 18/687,543

(22) PCT Filed: Aug. 31, 2022
(86) PCT No.: PCT/US2022/075783

§ 371 Date: Feb. 28, 2024

Related U.S. Application Data
(60) Provisional application No. 63/240,657, filed on Sep. 3, 2021.

(51) Int. Cl. A61C 7/28; A61C 9/00; A61C 13/34

(52) U.S. Cl. CPC A61C 7/28; A61C 9/0053; A61C 13/34

(57) ABSTRACT

Methods of directly bonding a non-sliding archform to a patient's teeth are disclosed herein. An IDB tray with wells sized and shaped to form orthodontic brackets can be filled with a fluid, such as an adhesive or bonding agent. The IDB tray with the fluid-filled wells can be placed over the teeth of the patient. The fluid in the wells can contact the surfaces of the teeth. The fluid can be cured by way of exposure to UV light, forming orthodontic brackets and bonding the orthodontic brackets to the patient's teeth.

### CROSS REFERENCE TO RELATED APPLICATIONS

This application is a U.S. National Stage Application under 35 U.S.C. 371 of International Application No. PCT/US2022/075783, filed Aug. 31, 2022, which claims priority to U.S. Provisional Patent Application No. 63/240,657, filed Sep. 3, 2021, which are incorporated herein by reference in their entireties. Any and all applications, if any, for which a foreign or domestic priority claim is identified in the Application Data Sheet of the present application is hereby incorporated by reference under 37 CFR 1.57.

### BACKGROUND

### Field

The present disclosure relates in some aspects to non-sliding archforms and orthodontic brackets coupled to a patient's teeth.

### SUMMARY

Teeth can be moved by bonding orthodontic brackets to the lingual or buccal surfaces of a patient's teeth and coupling an archform to the bonded orthodontic brackets. The archform can exert forces on the brackets using sliding or non-sliding mechanics, which can cause the patient's teeth to move. However, in some instances, a tooth may not have sufficient lingual or buccal surface area for an orthodontic bracket to be bonded thereon. In some instances, it may be difficult and/or time consuming to load an indirect bonding (IDB) tray with orthodontic brackets and apply adhesive to the orthodontic brackets for bonding. In some instances, it may be difficult, expensive, and/or time consuming to manufacture orthodontic brackets, especially when manufacturing a variety of orthodontic brackets. In some instances, it may be difficult, expensive, and/or time consuming to couple an archform to orthodontic brackets after bonding. Accordingly, solutions and/or improvements to at least the foregoing are disclosed herein.

In some variants, a method of bonding an archform directly to a patient's teeth is disclosed herein. The method can include applying adhesive to a connector of an archform and/or a surface of a tooth of the patient. In some variants, the adhesive can be applied to only the connector. In some variants, the adhesive can be applied to only the surface of the tooth of the patient. In some variants, the adhesive can be applied to both the connector and the surface of the tooth of the patient. The method can include deflecting the archform. The method can include placing the connector on the surface of the tooth of the patient. The method can include curing the adhesive.

In some variants, the surface of the tooth can be a lingual surface or a buccal surface.

In some variants, curing the adhesive can include exposing the adhesive to ultraviolet light.

In some variants, a method of forming an orthodontic bracket is disclosed herein. The method can include depositing fluid in a well of an indirect bonding (IDB) tray. The well can be positioned and shaped to form an orthodontic bracket based on a position and shape of a digital bracket in a digital model of a patient's teeth. The method can include curing the fluid in the well to form the orthodontic bracket.

In some variants, the method can include scanning an inside of a mouth of a patient. The method can include creating a digital model of teeth of the patient. The method can include selecting a digital bracket to be placed on a digital tooth of the digital model. The method can include positioning the digital bracket at a location on a surface of the digital tooth of the digital model. The method can include forming the IDB tray based on the digital model with a well positioned and shaped to form the orthodontic bracket corresponding to the digital bracket.

In some variants, the method can include placing the IDB tray over the teeth of the patient.

In some variants, placing the IDB tray over the teeth off the patient can be performed before curing the fluid.

In some variants, the method can include removing the IDB tray form the teeth of the patient and coupling an archform to the orthodontic bracket.

In some variants, the fluid can be an adhesive.

In some variants, the method can include disposing an archform in the IDB tray such that the archform is coupled to orthodontic bracket upon curing.

In some variants, the method can include disposing a spring in the orthodontic bracket.

In some variants, the method can include disposing a spring in the well to be incorporated into the orthodontic bracket upon curing.

In some variants, a method of forming bonding masses on a patient's teeth with an embedded archform is disclosed herein. The method can include placing an archform in an indirect bonding (IDB) tray. The method can include depositing fluid in a well of the tray. The well can be positioned and shaped to form the bonding mass based on a position and shape of a digital bonding mass in a digital model of a patient's teeth. The connector of the archform can be disposed in the fluid. The method can include placing the IDB tray over the patient's teeth. The method can include curing the fluid in the well to form the bonding mass with the connector of the archform embedded in the bonding mass and bonding the bonding mass to a surface of the patient's teeth.

In some variants, the method can include scanning an inside of a mouth of a patient. The method can include creating a digital model of teeth of the patient. The method can include positioning a digital bonding mass at a location on a surface of the digital tooth of the digital model. The method can include forming the IDB tray based on the digital model with a well positioned and shaped to form the bonding mass corresponding to the digital bonding mass.

In some variants, the fluid can be an adhesive.

In some variants, the method can include dissolving the IDB tray.

In some variants, an indirect bonding (IDB) tray is disclosed herein. The IDB tray can include a cavity that can receive a tooth of a patient. The IDB tray can include a well disposed in a surface of the IDB tray defining the cavity. The well can be shaped to form an orthodontic bracket when adhesive is deposited therein and cured.

In some variants, the well can be positioned and shaped based on a position and shape of a digital bracket in a digital model of the patient's teeth.

In some variants, the IDB tray can include retention features that can retain an archform.

In some variants, the IDB tray can be water soluble.

In some variants, an indirect bonding (IDB) tray is disclosed herein. The IDB tray can include a cavity that can receive a tooth of a patient. The IDB tray can include a well disposed in a surface of the IDB tray defining the cavity. The well can be shaped to form a bonding mass when adhesive is deposited therein and cured. The IDB tray can include one or more retention features that can retain an archform proximate the well such that a connector portion of the archform can be embedded in the bonding mass when formed.

In some variants, the well can be positioned and shaped based on a position and shape of a digital bonding mass in a digital model of the patient's teeth.

In some variants, a method of moving a patient's teeth to a planned alignment and retaining the patient's teeth in the planned alignment is disclosed herein. The method can include placing an archform in an indirect bonding (IDB) tray. The method can include depositing fluid in a well of the tray. The well can be positioned and shaped to form the bonding mass based on a position and shape of a digital bonding mass in a digital model of a patient's teeth. A connector of the archform can be disposed in the fluid. The method can include placing the IDB tray over the patient's teeth. The method can include curing the fluid in the well to form the bonding mass with the connector of the archform embedded in the bonding mass and bonding the bonding mass to a surface of the patient's teeth. The archform may move the patient's teeth to a planned alignment in the digital model and then retain the patient's teeth in the planned alignment.

In some variants, the method can include scanning an inside of a mouth of a patient. The method can include creating a digital model of teeth of the patient. The method can include positioning a digital bonding mass at a location on a surface of the digital tooth of the digital model. The method can include forming the IDB tray based on the digital model with a well positioned and shaped to form the bonding mass corresponding to the digital bonding mass.

In some variants, the fluid may be an adhesive.

In some variants, the method may include dissolving the IDB tray.

In some variants, a method of moving a patient's teeth to a planned alignment and retaining the patient's teeth in the planned alignment is disclosed herein. The method can include placing a plurality of pads in wells of an IDB tray. The wells may be positioned based on positions of digital pads on digital teeth in a digital model of a patient's teeth. The method can include applying adhesive the pads. The method can include placing the IDB tray over the patient's teeth such that the pads are positioned on teeth of the patient based on the positions of the digital pads on the digital teeth in the digital model of the patient's teeth. The method can include curing the adhesive to bond the pads to the teeth. The method can include bonding connectors of an archform to the pads. The archform may move the patient's teeth to a planned alignment in the digital model and then retain the patient's teeth in the planned alignment.

In some variants, the method can include scanning an inside of a mouth of the patient. The method can include creating the digital model of patient's teeth. The method can include positioning the digital pads on surfaces of the digital teeth of the digital model. The method can include customizing the digital pads based on the characteristics of the digital teeth. The method can include manufacturing the pads based on the customized digital pads.

In some variants, the method can include forming the IDB tray based on the digital model with the wells positioned based on the positions of the digital pads on the digital teeth in the digital model of the patient's teeth.

In some variants, forming the IDB tray can include 3D printing.

In some variants, manufacturing the customized pads may include 3D printing.

In some variants, the archform may be a last archform in a treatment plan for the patient. The method may include bonding orthodontic brackets to the pads. The method may include coupling a first archform to the orthodontic brackets to move the patient's teeth toward the planned alignment. The method may include decoupling the first archform from the orthodontic brackets. The method may include removing the orthodontic brackets from the pads.

In some variants, a method of moving a patient's teeth to a planned alignment and retaining the patient's teeth in the planned alignment is disclosed herein. The method may include bonding a plurality of pads to a patient's teeth in positions based on positions of digital pads on digital teeth in a digital model of the patient's teeth. The method may include bonding a plurality of orthodontic brackets to the pads. The method may include coupling a first archform to the orthodontic brackets. The first archform may move the patient's teeth toward a planned alignment in the digital model. The method may include decoupling the first archform from the orthodontic brackets. The method may include removing the plurality of orthodontic brackets from the pads. The method may include bonding a last archform to the pads. The last archform may move the patient's teeth to the planned alignment in the digital model and then retain the patient's teeth in the planned alignment.

In some variants, a method of moving a patient's teeth to a planned alignment and retaining the patient's teeth in the planned alignment is disclosed herein. The method may include bonding a plurality of orthodontic brackets to a plurality of pads. The method may include bonding the plurality of pads to a patient's teeth in positions based on positions of digital pads on digital teeth in a digital model of the patient's teeth. The method may include coupling a first archform to the orthodontic brackets, the first archform configured to move the patient's teeth toward a planned alignment in the digital model. The method may include decoupling the first archform from the orthodontic brackets. The method may include removing the plurality of orthodontic brackets from the pads. The method may include bonding a last archform to the pads. The last archform may move the patient's teeth to the planned alignment in the digital model and then retain the patient's teeth in the planned alignment.

In some variants, a method of moving a patient's teeth to a planned alignment and retaining the patient's teeth in the planned alignment is disclosed herein. The method may include bonding a plurality of pads to a patient's teeth in positions based on positions of digital pads on digital teeth in a digital model of the patient's teeth. The method may include bonding an archform to the pads. The archform may move the patient's teeth to a planned alignment in the digital model and then retain the patient's teeth in the planned alignment.

In some variants, the archform may include a plurality of connectors and a plurality of interproximal loops. The plurality of interproximal loops disposed between adjacent connectors of the plurality of connectors.

In some variants, each of the plurality of interproximal loops may extend gingivally.

### BRIEF DESCRIPTION OF THE DRAWINGS

These drawings are illustrative embodiments and do not present all possible embodiments of this invention. The illustrated embodiments are intended to illustrate, but not to limit, the scope of protection. Various features of the different disclosed embodiments can be combined to form further embodiments, which are part of this disclosure.

FIG. 1 illustrates a patient's teeth, including the upper and lower dental arches.

FIG. 2A illustrates an archform.

FIG. 2B illustrates another archform.

FIG. 3 illustrates a method of bonding an archform directly to a patient's teeth.

FIG. 4 illustrates an indirect bonding (IDB) tray.

FIG. 5 illustrates an orthodontic bracket with a spring removed.

FIGS. 6A and 6B illustrates the orthodontic bracket shown in FIG. 5 with the spring installed.

FIG. 7 illustrates the orthodontic bracket shown in FIGS. 6A and 6B with a connector portion of an archform disposed within the bracket.

FIG. 8 illustrates a method of forming orthodontic brackets on teeth of a patient.

FIG. 9 illustrates a method of forming bonding masses on a patient's teeth with an embedded archform.

FIG. 10 illustrates the archform of FIG. 2B bonded to custom bonding pads as a permanent retainer.

FIG. 11 illustrates a method of coupling an archform to a patient's teeth that moves the patient's teeth to a planned alignment and retains the teeth in the planned alignment.

### DETAILED DESCRIPTION

Malocclusion of the teeth may be treated using one or more archforms to move the patient's teeth using non-sliding and/or sliding mechanics. In some instances, orthodontic brackets can be bonded to one or more of the patient's teeth and an archform can be coupled to the bonded orthodontic brackets to exert forces on the brackets, resulting in movement of the teeth. In some variants, it may be desirable to directly bond an archform to a lingual or buccal surface of a patient's teeth.

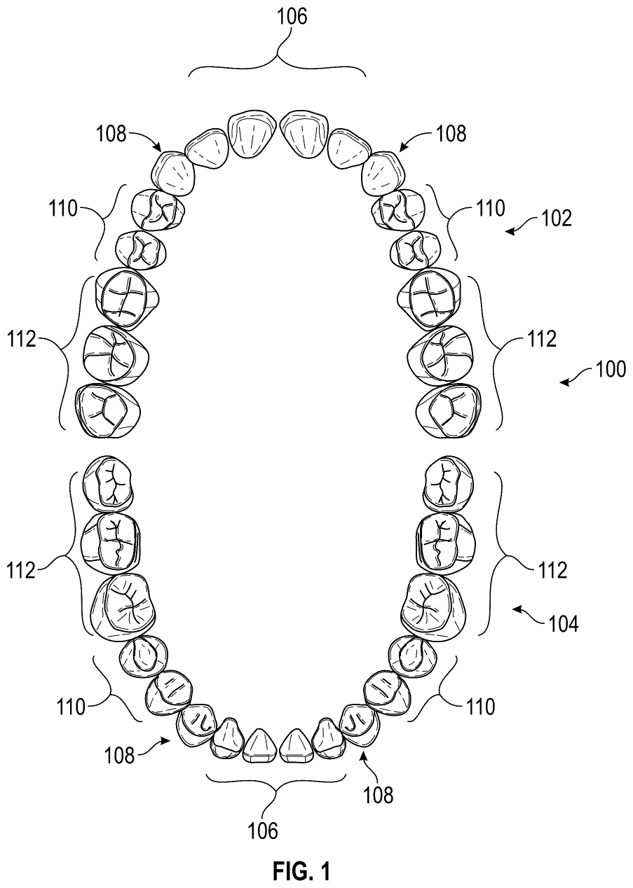

FIG. 1 illustrates teeth 100 of a patient, including the upper dental arch 102 and the lower dental arch 104. The human mouth includes a variety of teeth, including incisors 106, canines 108, premolars 110, and molars 112. Each of the foregoing varieties can have different characteristics, sizes, shapes, contours, and/or purposes. For example, incisors 106 are typically smaller than molars, while molars 112 are generally larger. In some instances, it may be advantageous due to tooth size, shape, and/or other characteristics to bond a connector of an archform directly to a patient's tooth without the use of an orthodontic bracket. For example, in some instances, insufficient surface area may be available on a patient's tooth to bond a prefabricated orthodontic bracket. Accordingly, in some instances, an archform may be directly bonded to a patient's teeth without the use of prefabricated orthodontic brackets.

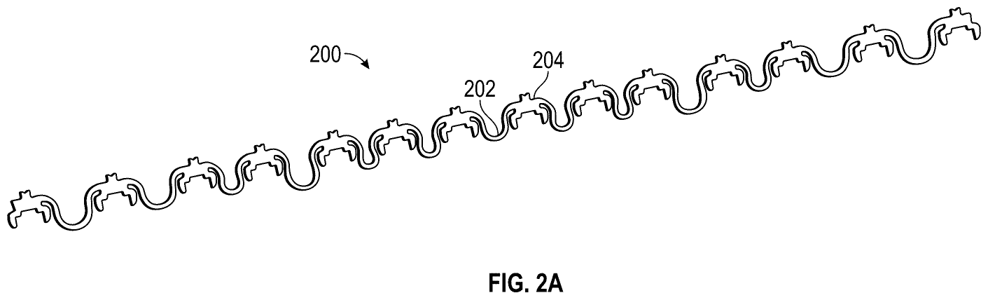

FIG. 2A illustrates an archform 200, which can also be referred to as an archwire. The illustrated embodiment of the archform 200 along with other embodiments of the archform are described in U.S. patent application Ser. No. 17/303,860, filed Jun. 9, 2021, now published as U.S. Publication No. 2021/0401548, the entirety of which is hereby incorporated by reference herein. The archform 200 can have a polygonal (e.g., rectangular), circular, and/or other shaped cross-section. The archform 200, as described herein, can be cut from a sheet of material, such as shape memory material (e.g., nickel titanium). The archform 200 can include a plurality of connectors or connector portions 204 that can be coupled to orthodontic brackets to install the archform 400 in the mouth of a patient and/or directly bonded to a patient's teeth without an orthodontic bracket. The connectors 204 can include one or more features (e.g., tongue, arms, etc.) to facilitate locking the connectors 204 within an orthodontic bracket.

The archform 200 can include a plurality of interproximal segments 202. The interproximal segments 202 can be disposed between adjacent connectors 204. The interproximal segment 202 can include one or more loops (e.g., one loop, as illustrated). The loops can extend in a gingival direction when the archform 200 is installed in the mouth, which can improve aesthetics and/or facilitate flossing. The loops can open to move adjacent teeth apart from each other. The loops can close to move adjacent teeth closer together.

As shown, the archform 200 is a two-dimensional shape. The archform 200 can be set in a custom nonplanar shape using a fixture and/or shaping system based on a digital model of a patient's teeth in second positions, which may be a planned alignment and/or final planned alignment of the teeth. The archform 200 can be held in the custom nonplanar shape by the fixture and/or shaping system and set by exposure to heat such that the custom nonplanar shape is the default or memorized position of the archform 200. The archform 200 can follow the entire upper or lower dental arch of a patient or a segment thereof. The archform 200 can be deflected from the memorized custom nonplanar shape and coupled to orthodontic brackets (e.g., coupling the connectors 204 to orthodontic brackets) bonded to the patient's teeth and/or directly bonded to the patient's teeth (e.g., directly bonding the connectors 204 to the patient's teeth). The archform 200 can exert forces on the brackets and/or directly on the patient's teeth, causing the teeth to move toward second positions (e.g., a final planned alignment) planned in the digital model.

FIG. 2B illustrates another archform 300, which can also be referred to as an archwire. The archform 300 can include at least all of the characteristics described in reference to FIG. 2A. The archform 300 can include connectors or connector portions 204 that are different than those described in reference to FIG. 2A. The connectors 204 of the archform 300 can omit features to facilitate convenient locking of the connectors 204 to an orthodontic bracket. The connectors 204 of the archform 300 can have a variety of shapes, which can include polygonal with rounded corners (e.g., square, rectangular, trapezoidal, etc.), circular, oval, irregular, and/or others. Omitting the features to facilitate convenient locking of the connectors 204 to orthodontic brackets, as shown in FIG. 2B, can improve user comfort when directly bonded to the patient's teeth and/or catch less food matter therein.

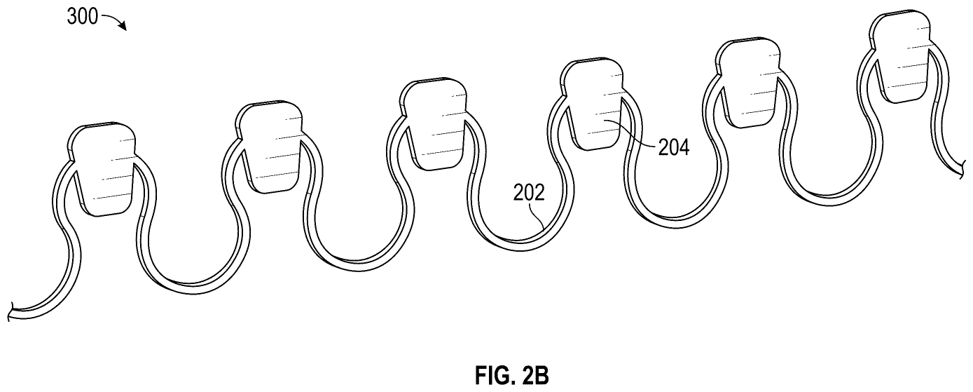

FIG. 3 illustrates a method 300 of bonding an archform directly to a patient's teeth. This flow diagram is provided for the purpose of facilitating description of aspects of some embodiments. The diagram does not attempt to illustrate all aspects of the disclosure and should not be considered limiting.

At block 302, an adhesive (e.g., bonding agent, glue, etc.) can be applied to a connector 204 of an archform, such as the archforms 200, 300. The adhesive can be applied to a surface of the connector 204 that is configured to contact a surface (lingual or buccal) of a tooth. In some variants, instead of applying adhesive to the connector 204, adhesive can be applied directly to a surface of the tooth at the location where the connector 204 will be bonded. In some variants, adhesive can be applied to both the connector 204 and directly to a surface of the tooth at the location where the connector 204 will be bonded. In some variants, the teeth of the patient and/or the connector 204 can be treated to facilitate improved adhesion of the adhesive to the connector 204 and/or surface of the teeth. In some variants, a solution, such as a fluid, can be applied to the teeth of the patient and/or the connector 204 to facilitate improved adhesion of the adhesive. In some variants, the surface of the patient's teeth and/or connector 204 can be texturized and/or a texturized material can be applied thereto to facilitate improved adhesion of the adhesive.

At block 304, the archform 200, 300 can optionally be deflected or partially deflected from a custom nonplanar shape. In some variants, adhesive can be applied, as described in reference to block 302, to the connector 204 and/or the surface of the tooth before or after the archform is deflected or partially deflected.

At block 306, the connector 204 of the archform 200, 300 can be placed on the lingual or buccal surface of the tooth of the patient. In some variants, the surface of the connector 204 with adhesive applied thereon can be placed on the lingual or buccal surface of the tooth of the patient.

At block 308, the adhesive can be cured to bond the connector to the tooth of the patient. In some variants, the adhesive can be cured from exposure to air. In some variants, the adhesive can be cured from exposure to light, such as UV light.

In some variants, the processes described in reference to blocks 302-306 can be repeated until a plurality of connectors are placed on surfaces of the patient's teeth before curing adhesive. In some variants, the process described in reference to blocks 302-308 can be repeated such that a first connector is bonded or partially bonded to a surface of a tooth, then a second connector is bonded or partially bonded to a surface of a tooth, etc. In some variants, orthodontic brackets can be bonded to one or more of the patient's teeth to facilitate coupling the archform thereto while one or more connectors of the archform are directly bonded to the patient's teeth. With the archform 200, 300 deflected from the custom nonplanar shape and bonded to the patient's teeth, the archform 200, 300 can exert forces on the patient's teeth as the archform 200, 300 moves back toward the undeflected configuration such that the patient's teeth move toward a planned alignment of the digital model of the patient's teeth.

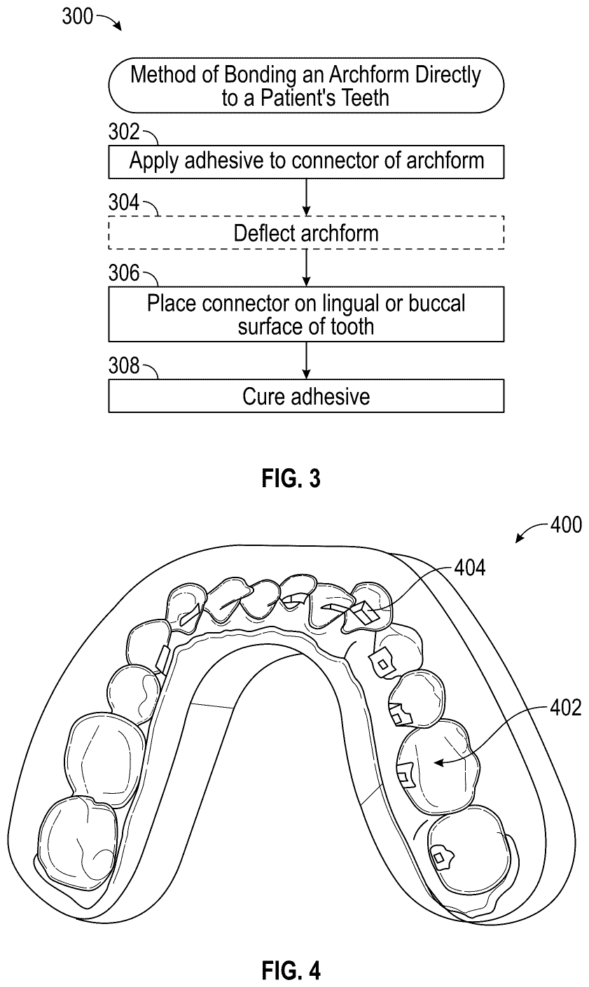

FIG. 4 illustrates an indirect bonding tray (IDB) tray 400, which can be formed based on a digital model of the patient's teeth created using scans (e.g., 3D and/or 2D) with digital brackets and/or digital bonding masses disposed thereon. The IDB tray 400 can be used for a variety of purposes described herein. For example, the IDB tray 400 can be used to form orthodontic brackets on surfaces of the patient's teeth. The IDB tray 400 can be used to install an archform in the patient's mouth while forming the orthodontic brackets on surfaces of the patient's teeth. The IDB tray 400 can be used to couple an archform to one or more orthodontic brackets bonded to the patient's teeth. The IDB tray 400 can be used to form and place bonding masses with portions of an archform imbedded therein on the surfaces of the patient's teeth.

The IDB tray 400 can include cavities 402 configured to receive the teeth of the patient such that the IDB tray 400 can be disposed over the teeth of the patient. The IDB tray 400 can include handles to facilitate handling. The IDB tray 400 can be configured to be placed over an entire dental arch of the patient or a segment thereof. The IDB tray 400 can include wells 404 (e.g., pockets, recesses, cavities, etc.) sized and shaped to form orthodontic brackets corresponding to digital brackets of the digital model and/or bonding masses corresponding to digital bonding masses of the digital model. The wells 404 can be disposed in the surfaces of the IDB tray 400 forming the cavities 402.

In some variants, the IDB tray 400 can include features, such as grooves, hold, hooks, inserts (metal or otherwise), etc. to retain an archform therein for installing in the mouth of the patient. The archform can be retained in a deflected shape from the memorized custom nonplanar shape such that, after placement in the patients mouth in a coupled arrangement with the cured orthodontic brackets and/or bonding masses, the archform can apply forces to the patient's teeth, as the archform moves toward the memorized custom nonplanar shape, moving the patient's teeth from positions of malocclusion to second positions (e.g., planned alignment and/or final planned alignment). In some variants, the IDB tray 400 can include features to hold springs respectively in the wells 404 to be formed as part of the bracket. The IDB tray 400 can be formed by 3D printing, machining, and/or molding a material over a physical model of the patient's teeth, which may include nonfunctional brackets or protuberances to form the wells 404.

In use, a clinician or operator can deposit a fluid, such as an adhesive or bonding agent, in the wells 404 of the IDB tray 400. The IDB tray 400, with the wells 404 having fluid therein, can be disposed over the teeth of the patient, placing the wells 404 at locations corresponding to the digital brackets in the digital model. The fluid can contact the surface of the teeth and be cured. In some variants, the fluid in the wells 404 can cure to form orthodontic brackets, based on the shape of the wells 404, directly bonded, respectively, to surfaces of the patient's teeth. The cured orthodontic brackets can correspond in at least shape, size, and/or placement to the digital brackets of the digital model. In some variants, the brackets can be cured in the IDB tray 400 outside of the user's mouth and then bonded to the teeth of the patient by applying adhesive to exposed bonding surfaces of the cured brackets.

In some variants, an archform can carried by the IDB tray 400 such that the archform is coupled to the cured orthodontic brackets. In some variants, a spring can be inserted into the wells 404 to incorporate a spring into the orthodontic brackets during curing and/or added to the orthodontic brackets after being cured. In some variants, a spring is not incorporated into the orthodontic brackets.

In some variants, the fluid in the wells 404 can cure to form bonding masses (e.g., bumps, humps, lumps, form, structure, etc.), based on the shape of the wells, directly bonded, respectively, to surfaces of the patient's teeth. The bonding masses can be formed and placed on the surfaces of the patient's teeth with portions, such as the connectors, of an archform imbedded therein. In some variants, the archform can be placed in the IDB tray 400 with portions (e.g., connectors) disposed in or proximate the wells 404 such that, upon depositing fluid in the wells 404, the portions of the archform are embedded (e.g., disposed) within the fluid. The cured bonding masses can correspond in at least shape, size, and/or placement to the digital bonding masses of the digital model. The fluid in the wells 404 can be cured via exposure to air and/or light, such as UV light. In some variants, the IDB tray 400 can be soluble in water and/or another fluid, enabling the IDB tray 400 to be dissolved in the patient's mouth after use (e.g., after placing one or more brackets, forming one or more brackets, placing an archform, placing and bonding an archform, etc.).

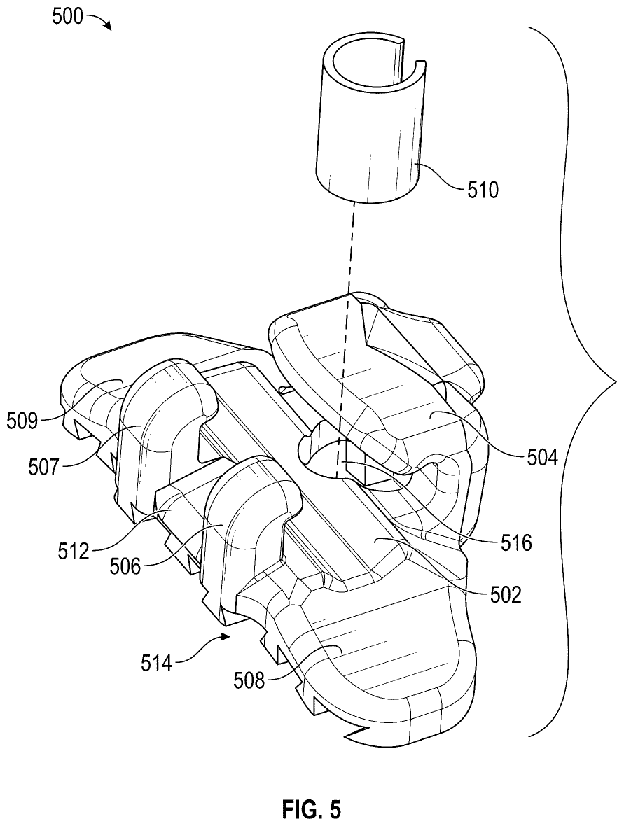

FIG. 5 illustrates a bracket 500, which may be formed in a well 404 of the IDB tray 400. The illustrated embodiment of the bracket 500 along with other embodiments of the bracket are described in U.S. patent application Ser. No. 17/303,860, filed Jun. 9, 2021, now published as U.S. Publication No. 2021/0401548, the entirety of which is hereby incorporated by reference herein. The wells 404 of the IDB tray 400 can form a variety of brackets with unique characteristics. The wells 404 are not limited to forming brackets that are the same as or similar to bracket 500.

As shown, the bracket 500 can include lateral extensions or wings 508, 509 that extend in the mesial-distal direction when the bracket 500 is formed and bonded to a tooth. In some variants, the bracket 500 may not include lateral extensions or wings 508, 509.

The bracket 500 can include a contact or bonding surface 514 that is configured to be bonded to the surface of a tooth of the patient. As illustrated, the lateral extensions 508, 509 increase the size of the contact surface 514, which can further increase the strength of the bond between the bracket 500 and the surface of the tooth. The bonding surface 514 can be exposed when the orthodontic brackets are being formed in the wells 404 of the IDB tray 400, which can facilitate the bonding surfaces 514 being bonded, respectively, to the surfaces of the teeth of the patient during curing.

The bracket 500 can include a variety of features that facilitate coupling to an archform. The bracket 500 can include a slot 502, which can extend in the medial-distal direction, disposed between a retainer 504 and stops 506, 507. The slot 502 can receive a connector of an archform therein such that the archform does not slide with respect to the bracket 500. The retainer 504 and the stops 506, 507 can at least prevent movement of the bracket connector relative to the bracket 500 in the gingival-occlusal direction. The bracket 500 can include a spring 510 (e.g., C-spring) that can lock the connector within the slot 502. The spring 510 can be disposed in the retainer 504 and push the connector against the stops 506, 507 to lock the connector within the slot 502. The spring 510 can be placed in the wells 504 and incorporated into the formed orthodontic bracket during curing and/or placed in the formed orthodontic bracket after curing. The spring 510 can be disposed in a hole or cavity 516 of the bracket 500. In some variants, the bracket 500 does not include a spring 510. A gap 512 can space apart the stops 506, 507 and receive a portion of the bracket connector therein such that the stops 506, 507 impede mesial-distal movement of the bracket connector relative to the bracket 500.

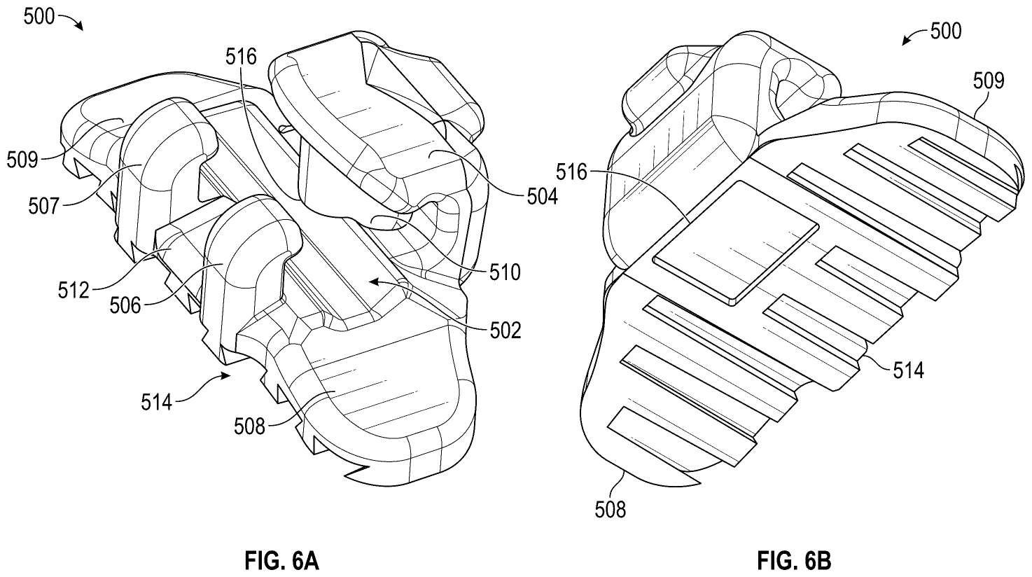

FIGS. 6A and 6B illustrate the bracket 500 with the spring 510 disposed in the hole or cavity 516.

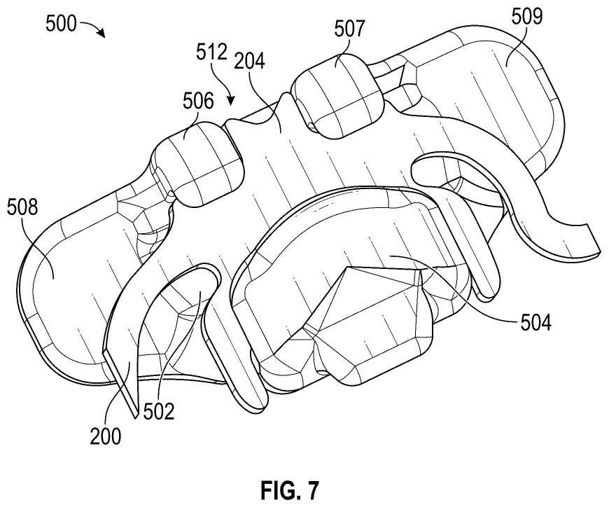

FIG. 7 illustrates the bracket 500 with a connector 204 of the archform 200 coupled thereto such that the connector 204 may not slide with respect to the bracket 500. The bracket connector 204 can be disposed within the slot 502 of the bracket 500. The stops 506, 507 and retainer 504 can cooperate to retain the bracket connector 204 within the slot and prevent movement of the bracket connector 204 in the occlusal-gingival direction. A portion of the bracket connector 204, e.g., the tongue or tab, can be disposed in the gap 512 between the stops 506, 507 which can help impede the connector 204 from sliding relative to the bracket 500 in the medial-distal direction. As described herein, the spring 510, when incorporated, can push the connector 204 against the stops 506, 507 locking the connector 204 within the bracket 500. In some variants, the connector 204 may be tied to the bracket 500. The bracket 500 can include tie wings.

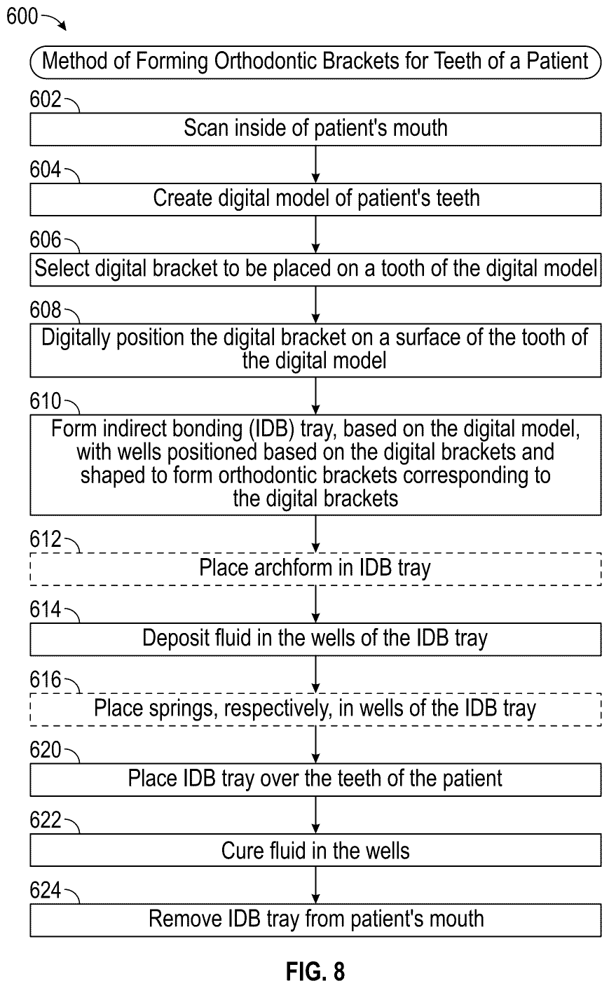

FIG. 8 illustrates an example method 800 of forming orthodontic brackets for teeth of a patient. This flow diagram is provided for the purpose of facilitating description of aspects of some embodiments. The diagram does not attempt to illustrate all aspects of the disclosure and should not be considered limiting.

At block 602, a scan (e.g., 3D scans and/or 2D scans) can be taken of the inside of the patient's mouth (e.g., dental arches). The scan can capture data regarding the type, size, shape, contours, surface features, positioning, and/or other characteristics of the patient's teeth. The scans can be taken by the patient, caretaker of the patient, and/or clinician. The scan can be performed using a camera and/or sensor of a computing device (e.g., computer, laptop, tablet, smartphone, mobile device, etc.) or device connected to a computing device. In some variants, an application can be used to perform the scans-providing the patient with instructions on how to perform the scan and when a scan is successful. The scan can be performed using the mobile device's built-in camera or via an attachment that operatively connects to the mobile device or computing device. The scanned data can be sent to a manufacturer of orthodontic appliances for processing and/or use.

At block 604, a digital model of the patient's teeth can be created based on scans of the inside of the patient's mouth. The digital model can represent the unique size, shape, contours, surface features, positioning, and/or other characteristics of the patient's teeth. The digital model can be displayed to an operator for viewing and/or manipulation. In some variants, the digital model can be automatically generated by software implemented on a computing device using the scans of the inside of the patient's mouth.

At block 606, a digital bracket suitable for bonding on a surface of a tooth can be selected from a variety of digital brackets. Certain types and/or sizes of brackets may be more suitable and/or preferred for bonding on a given tooth but not others. For example, a bracket with lateral extensions may be suitable for bonding on the molars 112 but not on the lower incisors 106 because of differences in size and shape. In some variants, an operator can select a digital bracket from a variety of digital brackets for placement on a tooth based on the type of tooth and/or features of the tooth shown in the digital model. In some variants, software implemented on a computing device may suggest one or more brackets from a variety of brackets for placement on a tooth based on the type of tooth and/or features of the relevant tooth. In some variants, software implemented on a computing device may select a bracket from a variety of brackets based on the type of tooth and/or features of the relevant tooth. In some variants, the operator may design a custom digital bracket for the patient.

At block 608, the selected digital bracket can be digitally placed on the surface of the relevant tooth of the digital model. In some variants, the operator can place the selected digital bracket on the surface (e.g., lingual or buccal surface) of the tooth in the digital model. In some variants, the selected digital bracket can be automatically placed by a software program on the surface of the tooth in the digital model. The processes described in reference to block 606 and block 608 can be repeated to select and respectively place a plurality of digital orthodontic brackets on surfaces of the teeth in the digital model, which can include every tooth of the digital model or only some of the teeth of the digital model. In some variants, the digital teeth are moved from positions corresponding to their scanned positions (e.g., maloccluded positions, original positions, first positions, etc.) to an alignment (e.g., planned alignment, final alignment, second positions), digital brackets are then selected and placed, and then the digital teeth are moved back positions corresponding to their scanned positions before proceeding to block 610, which can help determine that no collisions are likely to occur due to bracket placement during tooth movement.

At block 610, an IDB tray, based on the digital model with teeth in the scanned positions, can be formed, which can include 3D printing, over molding, machining, and/or other methods. The IDB tray can include wells, as described herein, that are positioned based on the digital brackets and shaped and sized to form orthodontic brackets corresponding to the digital brackets. In some variants, the IDB tray can include features, such as one or more metal inserts and/or other features described herein, to hold and retain an archform in the IDB tray. The archform can be held by the IDB tray in a configuration that is deflected from a memorized custom nonplanar shape to correctly place on the patient's teeth in the second positions. The archform can be custom shaped as described herein. The archform can be custom shaped as described in U.S. patent application Ser. No. 17/303,860, filed Jun. 9, 2021, now published as U.S. Publication No. 2021/0401548, the entirety of which is hereby incorporated by reference herein.

At block 612, an archform can, optionally, be disposed in and/or on the IDB tray. As described herein, the IDB tray can include one or more features to hold the archform therein. The IDB tray can hold the archform in a configuration deflected from the custom nonplanar shape to place on the patient's teeth in the first positions. In some variants, the archform is not disposed in and/or on the IDB tray during bracket forming but, instead, is coupled to the brackets after curing.

At block 614, fluid, such as adhesive and/or bonding agent, can be deposited into the wells of the IDB tray, such that the fluid assumes the shape defined by the wells. In some variants, a syringe can be used to deposit fluid in the wells. In some variants, the IDB tray can include an indicator that can visually indicate the extent to which a well should be filled, such as a fill line. In some variants, a fill guide can be used that indicates a quantity, which can include visually indicating, of fluid to deposit in a specific well, which can be based on the shape and size of the well and/or the unique characteristics of the patient's teeth. In some variants, a syringe used to deposit the fluid in the wells can include features (e.g., line(s)) to indicate how much fluid should be deposited.

At block 616, springs can optionally be placed in the wells of the IDB tray. In some variants, springs are incorporated into the cured orthodontic brackets after curing. In some variants, no springs are incorporated into the brackets. In some variants, ties are used to couple the cured orthodontic brackets and the archforms. The cured orthodontic brackets can include tie wings to facilitate the use of ties.

At block 620, the IDB tray can be placed over the teeth of the patient. The fluid in the wells of the IDB tray can contact the surfaces of the teeth through an opening of the wells. The fluid can be sufficiently viscous such that the fluid does not immediately flow out of the wells upon maneuvering the IDB tray over the teeth of the patient. In some variants, the fluid can be cured in the wells before placement of the IDB tray over the teeth of the patient and adhesive can be applied to surfaces of the cured brackets before placement of the IDB tray over the teeth of the patient to bond the cured brackets to the patient's teeth.

At block 622, the fluid in the wells of the IDB tray can be cured. The curing of the fluid can form the orthodontic brackets based on the shape and size of the wells. The fluid can be cured on the surfaces of the patient's teeth such that the cured orthodontic brackets are bonded on the surfaces of the patient's teeth. The fluid can be bonded via exposure to air and/or light, such as UV light.

At block 624, the IDB tray can be removed from the patient's mouth. In some variants, the IDB tray can be cut to remove the IDB tray from the patient's mouth. In some variants, the IDB tray can be soluble in water and/or another fluid, enabling the IDB tray to be dissolved with the flushing of water and/or another fluid in the patient's mouth. In some variants, the archform is placed on the teeth by the IDB tray that forms the cured orthodontic brackets. In some variants, the archform is coupled to the cured brackets after removal of the IDB tray. In some variants, the IDB tray or a second tray can be used to couple the archform to the cured orthodontic brackets. For example, the archform can be deflected from the custom nonplanar shape and placed in the same IDB tray or another IDB tray to couple to the cured orthodontic brackets on the patient's teeth. A patient may be treated using a plurality of archforms (e.g., one, two, three, four, five, etc.). Accordingly, a first archform coupled to the patient's cured brackets may be removed and a second archform may be coupled to the patient's cured brackets in its place. In some variants, one or more pre-manufactured orthodontic brackets may be loaded into well(s) of the IDB tray and bonded to the patient's teeth, while one or more wells may be used to form orthodontic brackets as described herein. The method 600 and associated components should not be limited to systems using non-sliding mechanics but, instead, can be applied to systems using sliding mechanics and/or otherwise bond brackets to teeth. The method 600 can be used with systems using both non-sliding and sliding mechanics.

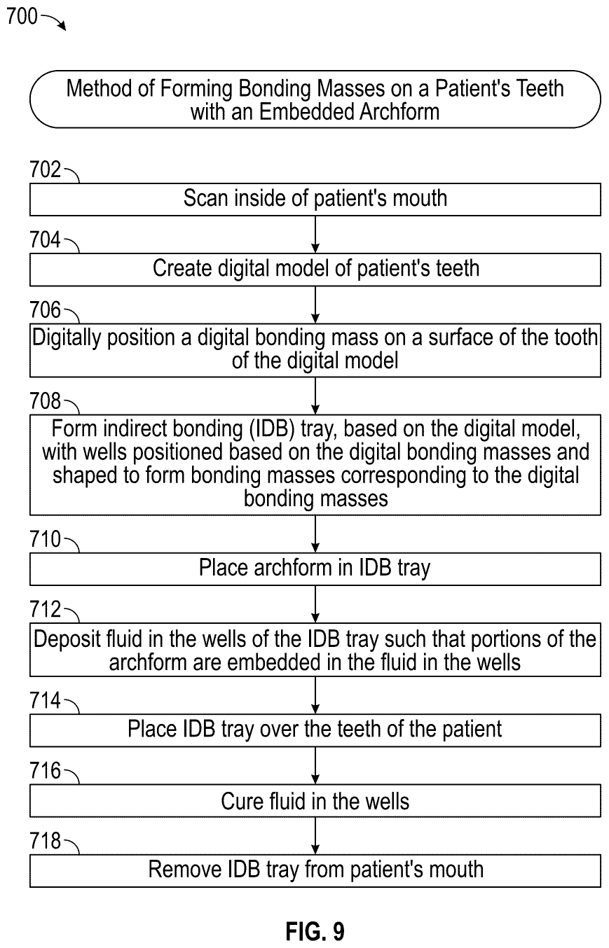

FIG. 9 illustrates an example method 700 of forming bonding masses on a patient's teeth with an embedded archform. This flow diagram is provided for the purpose of facilitating description of aspects of some embodiments. The diagram does not attempt to illustrate all aspects of the disclosure and should not be considered limiting.

At block 702, a scan (e.g., 3D scans and/or 2D scans) can be taken of the inside of the patient's mouth (e.g., dental arches), which can be the same as described in reference to method 600.

At block 704, a digital model of the patient's teeth can be created based on scans of the inside of the patient's mouth, which can be the same as described in reference to method 600.

At block 706, a digital bonding mass (e.g., bumps, humps, lumps, form, structure, etc.) can be digitally placed on the surface of the tooth of the digital model. The digital bonding mass can be selected from one or more types. The digital bonding mass can be custom designed. The digital bonding mass can be a variety of shapes and sizes. In some variants, the operator can place the digital bonding mass on the surface (e.g., lingual or buccal surface) of the tooth in the digital model. In some variants, the digital bonding mass can be automatically placed on the surface of the tooth in the digital model. The processes described in reference to block 706 and block 708 can be repeated to select and respectively place a plurality of digital bonding masses on surfaces of the teeth in the digital model, which can include every tooth of the digital model or only some of the teeth of the digital model.

At block 708, an IDB tray, based on the digital model, can be formed, which can include 3D printing, over molding, machining, and/or other methods. The IDB tray can include wells, as described herein, that are positioned based on the digital bonding masses and shaped and sized to form bonding masses corresponding to the digital bonding masses. In some variants, the IDB tray can include features, such as one or more metal inserts and/or other features, to hold and retain an archform in the IDB tray. The archform can be held by the IDB tray in a configuration that is deflected from a memorized custom nonplanar shape. The archform can be held by the IDB tray such that a portion (e.g., connector) of the archform is configured to be embedded within the bonding mass.

At block 710, the archform can be disposed in the IDB tray, which can include disposing a portion (e.g., connector) of the archform through or proximate the wells. The IDB tray, as described herein, can include retention features configured to hold the archform in a deflected position in the IDB tray. The archform can be deflected from a custom nonplanar shape and disposed in the IDB tray.

At block 712, fluid, such as adhesive and/or bonding agent, can be deposited into the wells of the IDB tray, such that the fluid assumes the shapes defined by the wells which can correspond to the shapes of the digital bonding masses. In some variants, a syringe can be used to deposit fluid in the wells. In some variants, the IDB tray can include an indicator that can visually indicate the extent to which a well should be filled, such as a fill line. In some variants, a fill guide can be used that indicates a quantity, which can include visually indicating, of fluid to deposit in a specific well, which can be based on the shape and size of the well and/or the unique characteristics of the patient's teeth. In some variants, a syringe used to deposit the fluid in the wells can include features (e.g., line(s)) to indicate how much fluid should be deposited.

At block 714, the IDB tray with the fluid-filled wells and archform can be placed over the teeth of the patient. The fluid in the wells of the IDB tray can contact the surfaces of the teeth through an opening of the wells. The fluid can be sufficiently viscous such that the fluid does not immediately flow out of the wells upon maneuvering the IDB tray over the teeth of the patient.

At block 716, the fluid in the wells of the IDB tray can be cured. The curing of the fluid can form the bonding masses based on the shape and size of the wells. The fluid can be cured on the surfaces of the patient's teeth such that the cured bonding masses are bonded on the surfaces of the patient's teeth. The fluid can be bonded via exposure to air and/or light, such as UV light. The portions of the archform disposed in the fluid can be embedded in the cured bonding masses, coupling the portions of the archform to the patient's teeth.

At block 718, the IDB tray can be removed from the patient's mouth, as at least described in reference to method 700. With the IDB tray removed, the archform can exert forces on the bonding masses, causing the patient's teeth to move toward second positions (e.g., alignment, planned alignment, preplanned alignment). The archform can move toward the memorized custom nonplanar shape, moving the teeth toward the second positions. In some variants, with the teeth moved to the second positions, the archform can be removed. In some variants, the archform can remain bonded to the patient's teeth, even after the teeth have moved to the second positions, to act as a permanent retainer, retaining the patient's teeth in the second positions.

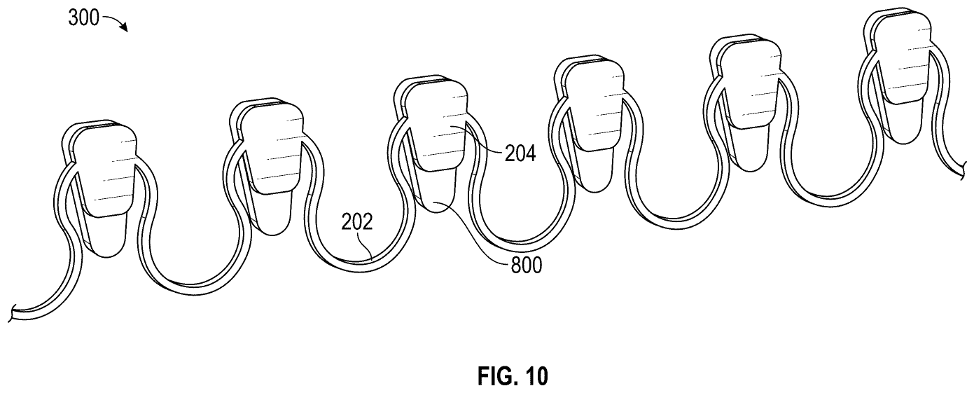

FIG. 10 illustrates the archform 300 with the connectors 204 coupled (e.g., adhered, bonded) to bonding pads 800, which may be custom bonding pads, that can be bonded to a patient's teeth. As described herein, teeth may have unique features that may make bonding to a given tooth difficult. For example, a tooth may have contours, texture, shape, size, etc. that would make it difficult to bond a connector 204 of the archform 300 or a bracket thereto. The custom bonding pads 800 can be manufactured to accommodate for the unique features of the patient's teeth to facilitate coupling the connectors 204 of the archform 300 or brackets to the patient's teeth. In some variants, brackets can be coupled to the custom bonding pads 800 during stages of a treatment plan as archforms are sequentially installed in a patient's mouth, and with a last archform, the brackets can be removed and the connectors of the last archform can be bonded to the custom bonding pads 800 such that the last archform can be comfortably left installed in a patient's mouth to function as a permanent retainer.

The custom bonding pads 800 can be digitally designed and manufactured based on 3D scans of the patient's teeth. The surface of a custom bonding pad 800 that will be adhered to given tooth of a patient can include custom features (e.g., shape, texture, size, contours, etc.) to accommodate for the features (e.g., shape, texture, size, contours, etc.) of the patient's tooth. For example, if a patient's tooth includes a groove, the custom bonding pad 800 may include a contour (e.g., ridge, bump, surface) that is designed to follow the shape of the groove to facilitate a secure bond between the custom bonding pad 800 and the patient's tooth, which may in turn facilitate a secure connection between the connector 204 of the archform 300 or bracket and the patient's tooth. In some variants, the custom bonding pads 800 may include any features of the orthodontic brackets disclosed herein and/or in U.S. patent application Ser. No. 17/303,860, filed Jun. 9, 2021, now published as U.S. Publication No. 2021/0401548, the entirety of which is hereby incorporated by reference herein.

The custom bonding pads 800 may be manufactured by way of a variety of techniques. In some variants, the custom bonding pads 800 may be 3D printed (e.g., additive manufacturing). In some variants, the custom bonding pads 800 may be machined. In some variants, the custom bonding pads 800 may be cast molded. In some variants, the custom bonding pads 800 may be injection molded. In some variants, the custom bonding pads 800 may be formed by curing a fluid (e.g., adhesive) in wells of an IDB tray, similar to the techniques described herein.

In some variants, the connectors 204 may be bonded to the custom bonding pads 800 with the custom bonding pads 800 bonded to a patient's teeth. In some variants, the connectors 204 may be bonded to the custom bonding pads 800 with the custom bonding pads 800 in the wells of the IDB tray. In some variants, the custom bonding pads 800 may be bonded to the connectors 204 of the archform 300 with the archform 300 held in an IDB tray, adhesive can be applied to the surfaces of the custom bonding pads 800 that are designed to bond to the teeth of the patient, the IDB tray can be placed over the patient's teeth, the adhesive can be cured to bond the custom bonding pads 800 to the teeth of the patient, and the IDB tray can be removed. In some variants, the custom bonding pads 800 may be bonded to a patient's teeth, and the archform 300 may be loaded into an IDB tray, adhesive applied to the connectors 204, and the IDB tray placed over the patient's teeth such that the connectors 204 adhere to the custom bonding pads 800.

In some variants, instead of using custom bonding pads 800, the surfaces of the connectors 204 that are designed to face the surfaces of the patient's teeth may be custom configured, similar to the custom bonding pads 800, to facilitate secure bonding to the patient's teeth. In some variants, after the patient's teeth have moved to the second positions, the archform 300 may be decoupled from the custom bonding pads 800 and a permanent retainer may be bonded to the custom bonding pads 800. In some variants, the archform 300 can remain bonded to the custom bonding pads 800, even after the teeth have moved to the second positions, to act as a permanent retainer to retain the patient's teeth in the second positions. The loops of the interproximal segments 202 can advantageously permit the patient to easily floss between adjacent teeth.

In some variants, a bracket, such as those described herein, can be bonded to the custom bonding pads 800. For example, the custom bonding pads 800 may be bonded to a patient's teeth and brackets may be coupled (e.g., adhered, bonded) to the custom bonding pads 800. The patient may be treated by sequentially installing a series of archforms (e.g., decoupling and coupling to the brackets) to move the patient's teeth toward the planned alignment. In some variants, with the last archform of a treatment plan, the brackets can be removed and the last archform can be bonded to the custom bonding pads 800 to move the patient's teeth to the second positions and left in place to be a permanent retainer. The custom bonding pads 800, without the brackets, may have a lower profile and/or less features to collect food material, which may improve user comfort and/or facilitate easier dental hygiene. In some variants, after the last archform of a treatment plan, the brackets can be removed and a permanent retainer, which may be similar to the archform 300, can be bonded to the custom bonding pads 800 to retain the patient's teeth in the second positions. In some variants, a patient may only require a single archform to move the patient's teeth from the first positions to the second positions (e.g. planned alignment, final planned alignment). Accordingly, the archform 300 can be bonded to the custom bonding pads 800 bonded to the patient's teeth to move the patient's teeth to a planned alignment and left in place after the patient's teeth are in the planned alignment to act as permanent retainer to retain the patient's teeth in the second positions.

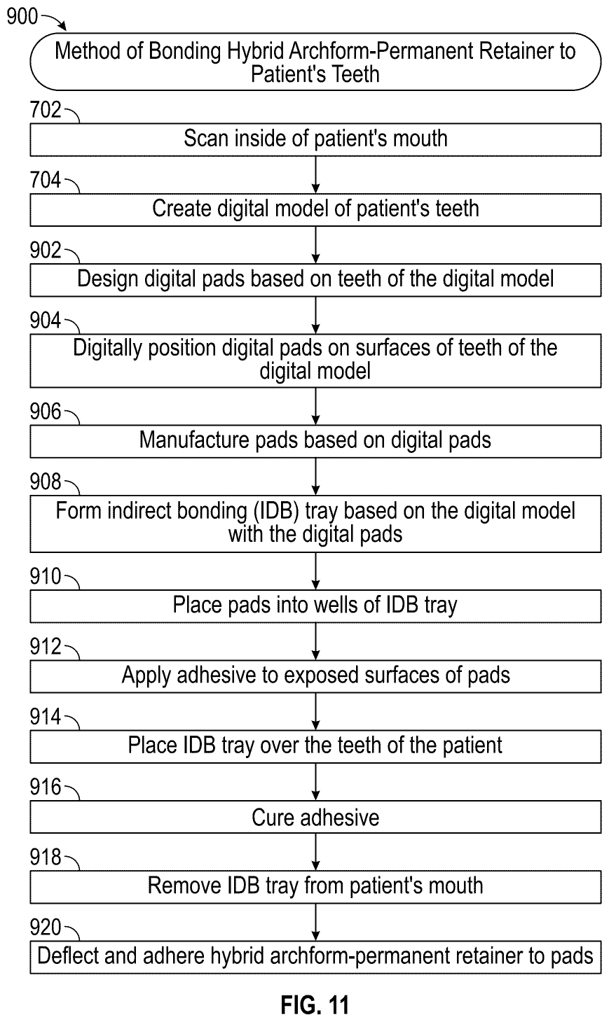

FIG. 11 illustrates an example method 900 of bonding a hybrid archform-permanent retainer to a patient's teeth. This flow diagram is provided for the purpose of facilitating description of aspects of some embodiments. The diagram does not attempt to illustrate all aspects of the disclosure and should not be considered limiting.

At block 702, a scan (e.g., 3D scans and/or 2D scans) can be taken of the inside of the patient's mouth (e.g., dental arches), which can be the same as described in reference to method 600.

At block 704, a digital model of the patient's teeth can be created based on scans of the inside of the patient's mouth, which can be the same as described in reference to method 600.

At block 902, digital bonding pads, which may be custom digital bonding pads, can be digitally designed based on the digital model of the patient's teeth. The size, shape, texture, contours, etc. of the digital custom bonding pads can be designed based on the digital model of the patient's teeth. The surface of a digital custom bonding pad that corresponds to a custom bonding pad that will be adhered to a given tooth of a patient can include custom features (e.g., shape, texture, size, contours, etc.) to accommodate for the features (e.g., shape, texture, size, contours, etc.) of the patient's tooth, which may be represented by the digital model of the patient's tooth. For example, if the digital model of a patient's tooth includes a groove, the digital custom bonding pad may include a contour (e.g., ridge, bump, surface) that is designed to follow the shape of the groove to facilitate a secure bond between the custom bonding pad and the patient's tooth, which may in turn facilitate a secure connection between the connector of the archform and/or bracket and the patient's tooth. In some variants, all of the digital bonding pads are customized. In some variants, some of the digital bonding pads are customized while others are not. In some variants, none of the digital bonding pads are customized, which may indicate that non-customized bonding pads will be sufficient to facilitate secure bonding. In some variants, a digital bonding pad may be provided, which may be subsequently customized in the digital model. In some variants, a digital bonding pad may be placed proximate a digital tooth and a software program may customize the surface of the bonding pad facing the tooth surface based on the features of the tooth surface.

At block 904, the digital pads, which may be custom digital pads, may be disposed on the surfaces of the digital teeth of the digital model. In some variants, the steps performed at blocks 902 and 904 can occur at the same time. The digital pads may be disposed on the lingual or buccal surfaces of the patient's teeth. In some variants, an operator may place the digital pads. In some variants, a software program may place the digital pads. In some variants, a software program may recommend placement of the digital pads and the operator may modify placement.

At block 906, the bonding pads, which may be custom bonding pads, may be manufactured based on the digital custom bonding pads. The custom bonding pads may be manufactured by way of a variety of techniques. In some variants, the custom bonding pads may be 3D printed (e.g., additive manufacturing). In some variants, the custom bonding pads may be machined. In some variants, the custom bonding pads may be cast molded. In some variants, the custom bonding pads may be injection molded. In some variants, the custom bonding pads may be formed by curing a fluid (e.g., adhesive) in wells of an IDB tray, similar to the techniques described herein. In some variants, the custom bonding pads can include identifying information, which can include to which patient the custom bonding pad corresponds and to which tooth of the patient. In some variants, the custom bonding pads may be manufactured by way of a combination of any of the foregoing techniques.

At block 908, an IDB tray, based on the digital model, can be formed, which can include by way of 3D printing, over molding, machining, and/or other methods. The IDB tray can include wells, as described herein, that are positioned, shaped, and/or sized based on the digital pads such that the manufactured pads can be disposed in the wells for transfer to the patient's teeth. In some variants, the IDB tray can include features, such as one or more metal inserts and/or other features, to hold and retain an archform and/or permanent retainer in the IDB tray for placement.

At block 910, the manufactured pads (e.g., custom pads) can be disposed in the wells of the IDB tray. In some variants, the wells of the IDB tray can include features (e.g., notches, lips, tabs, hooks, flanges, etc.) to help retain the pads in the wells. In some variants, the IDB tray can include information to help guide a clinician as to placement of pads into wells to ensure that the correct pad is placed in a given well.

At block 912, adhesive or the like can be applied to exposed surfaces of the pads that will be bonded to the surfaces of the patient's teeth.

At block 914, the IDB tray loaded with the pads with applied adhesive can be placed over the patient's teeth such that the pads are located at positions on the patient's teeth that correspond to the placement of the digital pads in the digital model of the patient's teeth. The surfaces of the pads with the applied adhesive can contact the surfaces of the patient's teeth and bond the pads to the surfaces of the patient's teeth. In some variants, the adhesive can be cured with air, heat exposure, cold exposure, and/or light, such as UV light.

At block 918, the IDB tray can be removed from the patient's mouth. In some variants, the IDB tray may be cut or otherwise sectioned to facilitate removal from the patient's mouth. The IDB tray may include one or more perforations to facilitate sectioning of the IDB tray. In some variants, the IDB tray may be water soluble such that the patient's mouth may be flushed with water to dissolve the IDB tray in the patient's mouth.

At block 920, an archform may be deflected from a custom nonplanar shape and bonded to the pads bonded to the patient's teeth. In some variants, the connectors of the archform may be bonded to the pads without using an IDB tray. In some variants, the archform may be loaded into an IDB tray, which may be the same IDB tray used to place the bonding pads, and adhesive applied to the connectors of the archform. The loaded IDB tray can be placed over the patient's teeth to bond the connectors of the archform to the pads. The adhesive on the connectors can be cured via at least the techniques described herein to bond the connectors to the pads. Once bonded to the pads, the archform can apply forces to the patient's teeth to move the patient's teeth toward the alignment planned in the digital model. After the teeth have moved to the planned alignment, the archform can be left in the patient's mouth to act as a permanent retainer to retain the patient's teeth in the planned alignment. Accordingly, the archform may be a hybrid archform and permanent retainer. In some variants, the patient's teeth may be moved to the planned alignment with one or more archforms and, once in the planned alignment, a retainer, which can be similar in shape to the archforms, may be bonded to the pads.

In some variants, brackets can be bonded to the pads. For example, brackets can be disposed in wells of an IDB tray, adhesive can be applied to the surfaces of the brackets that will contact the pads, and the loaded IDB tray can be positioned over the teeth of the patient to bond the brackets to the pads. In some variants, the brackets can be individually bonded to the pads with or without the assistance of an IDB tray. A series (e.g., two, three, four, or more) of archforms can be sequentially installed in the patient's mouth to move the patient's teeth toward the planned alignment. For example, a first archform can be coupled to the brackets to move the patient's teeth toward the planned alignment. The first archform can be removed and a second archform can be coupled to the brackets to continue to move the patient's teeth toward the planned alignment. In some variants, before a last archform is installed, the brackets can be debonded from the pads and the connectors of the last archform can be directly bonded to the pads. In some variants, the archforms installed before the last archform may be similar to the archform 200, which may include features to help couple the archform 200 to brackets, while the last archform may be similar to the archform 300, which may not include features to help couple the archform 300 to brackets. The last archform may move the patient's teeth to the planned alignment and then be left in the patient's mouth as a permanent retainer to retain the patient's teeth in the planned alignment. In some variants, a patient's treatment plan may only include one archform; accordingly, brackets may not be bonded to the pads and, instead, the connectors of the one archform may be directly bonded to the pads. The one archform may move the patient's teeth to the planned alignment and then be left in the patient's mouth as a permanent retainer.

In some variants, the pads may be bonded to brackets before installation in a patient's mouth. For example, the pads can be bonded to the brackets and then the bonded pads and brackets can be loaded (e.g., disposed) into the wells of the IDB tray for placement. The surfaces of the pads that are designed to bond to the teeth can have adhesive applied thereto. The loaded IDB tray can then be placed over the patient's teeth and the pads, with the bonded brackets, can be bonded to the patient's teeth. In some variants, the brackets may be loaded (e.g., disposed) into wells of an IDB tray and then the pads can be bonded to the loaded brackets. In some variants, pads may be bonded to brackets and then the brackets may be coupled to an archform; the archform, brackets, and pads may then together be disposed in an IDB tray for placement on the patient's teeth. In some variants, brackets may be coupled to an archform and then the pads may be bonded to the brackets; the archform, brackets, and pads may then together be disposed in an IDB tray for placement on the patient's teeth. In some variants, the archform may be loaded into an IDB tray, brackets can then be coupled to the connectors of the archform, and then pads may be bonded to the brackets; adhesive may then be applied to the pads and the loaded IDB tray may be placed over the teeth of the patient. In some variants, the brackets may be coupled to the connectors of the archform and then the brackets and archform can together be loaded into the IDB tray. The pads may then be bonded to the brackets, adhesive applied to the pads, and the loaded IDB tray may be placed over the teeth of the patient.

It is intended that the scope of this present invention herein disclosed should not be limited by the particular disclosed embodiments described above. This invention is susceptible to various modifications and alternative forms, and specific examples have been shown in the drawings and are herein described in detail. This invention is not limited to the detailed forms or methods disclosed, but rather covers all equivalents, modifications, and alternatives falling within the scope and spirit of the various embodiments described and the appended claims. Various features of the orthodontic brackets and archforms described herein can be combined to form further embodiments, which are part of this disclosure. The orthodontic brackets described herein can be bonded to a patient's teeth and the archforms described herein can be deflected and coupled thereto as part of a treatment plan. The archforms can move toward a default position and move the patient's teeth from a first position to a second position. The archforms described herein can be installed in sequence to move the patient's teeth. The orthodontic brackets described herein can be bonded to the teeth of the patient in various orientations, which can include orienting the orthodontic bracket in a first gingival-occlusal orientation and reorienting the orthodontic bracket one hundred and eighty degrees to a second gingival-occlusal orientation (e.g., rotating the orthodontic bracket one hundred and eighty degrees).

Methods of using the orthodontic brackets and/or archforms (including device(s), apparatus(es), assembly(ies), structure(s) or the like) are included herein; the methods of use can include using or assembling any one or more of the features disclosed herein to achieve functions and/or features of the system(s) as discussed in this disclosure. Methods of manufacturing the foregoing system(s) are included; the methods of manufacture can include providing, making, connecting, assembling, and/or installing any one or more of the features of the system(s) disclosed herein to achieve functions and/or features of the system(s) as discussed in this disclosure.

Various other modifications, adaptations, and alternative designs are of course possible in light of the above teachings. Therefore, it should be understood at this time that within the scope of the appended claims the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “tying a tie onto an orthodontic bracket” includes “instructing the tying of a tie onto an orthodontic bracket.” The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

What is claimed is:

1. A method of bonding an archform directly to a patient's teeth, the method comprising:
applying adhesive to a connector of an archform and/or a surface of a tooth of the patient;
deflecting the archform;
placing the connector on the surface of the tooth of the patient; and
curing the adhesive.

2. The method of claim 1, wherein the surface of the tooth is a lingual surface or a buccal surface.

3. The method of claim 1 or 2, wherein curing the adhesive comprises exposing the adhesive to ultraviolet light.

4. A method of forming an orthodontic bracket, the method comprising:
depositing fluid in a well of an indirect bonding (IDB) tray, the well positioned and shaped to form an orthodontic bracket based on a position and shape of a digital bracket in a digital model of a patient's teeth; and
curing the fluid in the well to form the orthodontic bracket.

5. The method of claim 4, further comprising:
scanning an inside of a mouth of a patient;
creating a digital model of teeth of the patient;
selecting a digital bracket to be placed on a digital tooth of the digital model;
positioning the digital bracket at a location on a surface of the digital tooth of the digital model;
forming the IDB tray based on the digital model with a well positioned and shaped to form the orthodontic bracket corresponding to the digital bracket.

6. The method of any of claims 4 and 5, further comprising placing the IDB tray over the teeth of the patient.

7. The method of claim 6, wherein placing the IDB tray over the teeth off the patient is performed before curing the fluid.

8. The method of any of claims 4-7, further comprises removing the IDB tray form the teeth of the patient and coupling an archform to the orthodontic bracket.

9. The method of any of claims 4-8, wherein the fluid is an adhesive.

10. The method of any of claims 4-9, further comprising disposing an archform in the IDB tray such that the archform is coupled to orthodontic bracket upon curing.

11. The method of any of claims 4-10, further comprising disposing a spring in the orthodontic bracket.

12. The method of any of claims 4-11, further comprising disposing a spring in the well to be incorporated into the orthodontic bracket upon curing.

13. A method of forming bonding masses on a patient's teeth with an embedded archform, the method comprising:
placing an archform in an indirect bonding (IDB) tray;
depositing fluid in a well of the IDB tray, the well positioned and shaped to form the bonding mass based on a position and shape of a digital bonding mass in a digital model of a patient's teeth, wherein a connector of the archform is disposed in the fluid;
placing the IDB tray over the patient's teeth; and
curing the fluid in the well to form the bonding mass with the connector of the archform embedded in the bonding mass and bonding the bonding mass to a surface of the patient's teeth.

14. The method of claim 13, further comprising:
scanning an inside of a mouth of the patient;
creating a digital model of teeth of the patient;
positioning a digital bonding mass at a location on a surface of the digital tooth of the digital model;
forming the IDB tray based on the digital model with a well positioned and shaped to form the bonding mass corresponding to the digital bonding mass.

15. The method of any of claim 13 or 14, wherein the fluid is an adhesive.

16. The method of any of the preceding claims, further comprising dissolving the IDB tray.

17. An indirect bonding (IDB) tray, the IDB tray comprising:
a cavity configured to receive a tooth of a patient; and
a well disposed in a surface of the IDB tray defining the cavity, the well shaped to form an orthodontic bracket when adhesive is deposited therein and cured.

18. The IDB tray of claim 17, wherein the well is positioned and shaped based on a position and shape of a digital bracket in a digital model of the patient's teeth.

19. The IDB tray of any of claim 17 or 18, further comprising retention features configured to retain an archform.

20. The IDB tray of any of claims 17-19, wherein the IDB tray is water soluble.

21. An indirect bonding (IDB) tray, the IDB tray comprising:
a cavity configured to receive a tooth of a patient;
a well disposed in a surface of the IDB tray defining the cavity, the well shaped to form a bonding mass when adhesive is deposited therein and cured; and
one or more retention features configured to retain an archform proximate the well such that a connector portion of the archform is embedded in the bonding mass when formed.

22. The IDB tray of claim 21, wherein the well is positioned and shaped based on a position and shape of a digital bonding mass in a digital model of the patient's teeth.

23. A method of moving a patient's teeth to a planned alignment and retaining the patient's teeth in the planned alignment, the method comprising:
placing an archform in an indirect bonding (IDB) tray;
depositing fluid in a well of the tray, the well positioned and shaped to form the bonding mass based on a position and shape of a digital bonding mass in a digital model of a patient's teeth, wherein a connector of the archform is disposed in the fluid;
placing the IDB tray over the patient's teeth; and
curing the fluid in the well to form the bonding mass with the connector of the archform embedded in the bonding mass and bonding the bonding mass to a surface of the patient's teeth;
wherein the archform is configured to move the patient's teeth to a planned alignment in the digital model and then retain the patient's teeth in the planned alignment.

24. The method of claim 23, further comprising:
scanning an inside of a mouth of a patient;
creating a digital model of teeth of the patient;
positioning a digital bonding mass at a location on a surface of the digital tooth of the digital model;
forming the IDB tray based on the digital model with a well positioned and shaped to form the bonding mass corresponding to the digital bonding mass.

25. The method of any of claims 23 and 24, wherein the fluid is an adhesive.

26. The method of any of claims 23-25, further comprising dissolving the IDB tray.

27. A method of moving a patient's teeth to a planned alignment and retaining the patient's teeth in the planned alignment, the method comprising:
placing a plurality of pads in wells of an IDB tray, the wells positioned based on positions of digital pads on digital teeth in a digital model of a patient's teeth;
applying adhesive the pads;
placing the IDB tray over the patient's teeth such that the pads are positioned on teeth of the patient based on the positions of the digital pads on the digital teeth in the digital model of the patient's teeth;
curing the adhesive to bond the pads to the teeth; and
bonding connectors of an archform to the pads;
wherein the archform is configured to move the patient's teeth to a planned alignment in the digital model and then retain the patient's teeth in the planned alignment.

28. The method of claim 27, further comprising:
scanning an inside of a mouth of the patient;
creating the digital model of patient's teeth;
positioning the digital pads on surfaces of the digital teeth of the digital model;
customizing the digital pads based on the characteristics of the digital teeth; and
manufacturing the pads based on the customized digital pads.

29. The method of any of claims 27 and 28, further comprising forming the IDB tray based on the digital model with the wells positioned based on the positions of the digital pads on the digital teeth in the digital model of the patient's teeth.

30. The method of any of claim 29, wherein forming the IDB tray comprises 3D printing.

31. The method of any of claim 28, wherein manufacturing the customized pads comprises 3D printing.

32. The method of any of claims 27-31, wherein the archform is a last archform in a treatment plan for the patient and further comprising:
bonding orthodontic brackets to the pads;
coupling a first archform to the orthodontic brackets to move the patient's teeth toward the planned alignment;
decoupling the first archform from the orthodontic brackets; and
removing the orthodontic brackets from the pads.

33. A method of moving a patient's teeth to a planned alignment and retaining the patient's teeth in the planned alignment, the method comprising:
bonding a plurality of pads to a patient's teeth in positions based on positions of digital pads on digital teeth in a digital model of the patient's teeth;
bonding a plurality of orthodontic brackets to the pads;
coupling a first archform to the orthodontic brackets, the first archform configured to move the patient's teeth toward a planned alignment in the digital model;
decoupling the first archform from the orthodontic brackets;
removing the plurality of orthodontic brackets from the pads; and
bonding a last archform to the pads;
wherein the last archform is configured to move the patient's teeth to the planned alignment in the digital model and then retain the patient's teeth in the planned alignment.

34. The method of claim 33, further comprising any of the features of claims 1-32.

35. A method of moving a patient's teeth to a planned alignment and retaining the patient's teeth in the planned alignment, the method comprising:
bonding a plurality of orthodontic brackets to a plurality of pads;
bonding the plurality of pads to a patient's teeth in positions based on positions of digital pads on digital teeth in a digital model of the patient's teeth;
coupling a first archform to the orthodontic brackets, the first archform configured to move the patient's teeth toward a planned alignment in the digital model;
decoupling the first archform from the orthodontic brackets;
removing the plurality of orthodontic brackets from the pads; and
bonding a last archform to the pads;
wherein the last archform is configured to move the patient's teeth to the planned alignment in the digital model and then retain the patient's teeth in the planned alignment.

36. The method of claim 35, further comprising any of the features of claims 1-32.

37. A method of moving a patient's teeth to a planned alignment and retaining the patient's teeth in the planned alignment, the method comprising:
bonding a plurality of pads to a patient's teeth in positions based on positions of digital pads on digital teeth in a digital model of the patient's teeth; and
bonding an archform to the pads;
wherein the archform is configured to move the patient's teeth to a planned alignment in the digital model and then retain the patient's teeth in the planned alignment.

38. The method of claim 37, further comprising any of the features of claims 1-36.

39. The method or IDB tray of any of the preceding claims, wherein the archform comprises a plurality of connectors and a plurality of interproximal loops, the plurality of interproximal loops disposed between adjacent connectors of the plurality of connectors.

40. The method or IDB tray of claim 39, wherein each of the plurality of interproximal loops extend gingivally.
